(19) United States
(12) Patent Application Publication
(10) Pub. No.: US 2004/0118180 A1
(43) Pub. Date: Jun. 24, 2004

(54) Method and system for determining average engraved surface depth by eddy currents

(76) Inventor: Michael Keating, Flintshire (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/471,905

(22) PCT Filed: Mar. 19, 2002
(86) PCT No.: PCT/GB02/01097

(30) Foreign Application Priority Data
Mar. 19, 2001 (GB) 0106686.9

(51) Int. Cl. G01B 3/30; B23C 1/12

(52) U.S. Cl. 73/1.81; 409/207

(57) ABSTRACT

The invention provides a system and network for determining the average engraved volume of an area such as the average volume of engraved cells on a gravure cylinder or plate for a printing press. In one embodiment the method comprises steps of: positioning a surface volume determining means (10) in the form of an eddy current sensor (12) in the proximity of an engraved surface (18); and inducing eddy currents in the engraved surface; and, measuring the impedance (14) of the inductor of the eddy current sensor to determine a value indicative of the average engraved volume of the engraved cells.

The invention relates to engraving and in particular concerns a method and system for determining the average engraved surface depth of an engraved area on a printing surface used for gravure or flexographic printing.

Gravure cylinders for printing are engraved using special gravure engraving machines which may comprise a diamond tipped stylus for engraving cells in the form of indentations in the outer surface of the cylinder. The stylus is caused to oscillate at several thousand cycles per second to form a pattern of cells in the surface of the gravure cylinder corresponding to text, image(s) or surface coating to be printed. Gravure cylinders and like components may also be engraved by chemical or photo etching and the latter may involve laser machining of cells in Copper or Zinc material. In this respect, the terms “engraving” and “engrave” used herein refer to engraving by the above mentioned methods and by any other means.

During printing the cells are filled with ink and the shape and size of each cell determines the volume of ink in the cell and therefore the size of the ink dot formed by the cell when printed. It is important to control the engraving process so that the cells are engraved to the required size since any deviation from this will cause the image to be distorted in terms of print density, that is to say, undersized cells will produce images that are lighter than required, and oversized cells will produce images that are darker than required.

Calibration of engraving machines usually involves engraving a small part of a gravure cylinder to produce a series of cells in the cylinder surface. The size of these cells is measured using known optical equipment such as a microscope to determine various cell dimensions such as height and width of the engraved cells. This information can be compared with engraver control parameters so that the parameters can be adjusted to calibrate the machine as required. This is a time consuming process and can add significantly to the time required to engrave a cylinder and is also subject to human errors. In addition, the measured dimensions only provide information on the size of the indentation at the surface and an assumption has to be made that the engraved volume of the cell is directly proportional to these dimensions based on the known geometry of the engraving stylus or electrode, or laser beam properties etc. As the stylus or electrode wears, the engraved volume will vary relative to the cell dimensions visible on the surface of the cylinder and therefore cause the engraver to go out of calibration. This can be monitored by producing test prints once the test cells have been engraved but again this adds significantly to the overall time of the engraving process.

One attempt to overcome the above problems is disclosed in U.S. Pat. No. 5,831,746, in which an image processor is used to measure the area of the engraved cell on the surface of the cylinder. Information and dimensional data relating to the size and profile of the stylus is used to determine the engraved volume of the cell. The stylus dimensions and profile are determined using an engraved test pattern in which cells are formed having a plurality of depths such that the cross section of the stylus at various depths can be determined by the area of the cell in accordance with the depth of the indentation forming the cell. Once the stylus dimensions and its cross-section profile have been determined the actual total volume of the engraved area can be calculated. One of the drawbacks associated with the system disclosed in U.S. Pat. No. 5,831,746 is that the image processing apparatus and software significantly add to the cost and complexity of the engraver. In addition errors may be introduced by the interpolation of points on the various cross-sections of the stylus when determining the profile thereof.

A different approach has been taken in U.S. Pat. No. 5,818,695 where an engraving apparatus is disclosed in which the cell volume is estimated by measuring the penetration of the engraving stylus in the cylinder surface. Positional changes of the engraving stylus are measured using either capacitors, resistors, impedance, optical, piezoelectric, or eddy current displacement sensors. The apparatus estimates cell volume on the basis of the estimated cell depth and compares this information with an engraving command signal given to create the cell so that an error factor can be determined, that is to say the so-called gamma parameter. A problem with the apparatus disclosed in U.S. Pat. No. 5,818,605 is that cell volume is estimated entirely from the estimated cell depth and therefore relies entirely on accurate profile date for the stylus and takes no account of stylus wear.

A further approach is described in U.S. Pat. No. 3,931,570. In this earlier published document a pair of series connected Hall devices are positioned within a probe which is located directly on the surface of a gravure cylinder. An alternating current having a frequency of 4 kHz to 50 kHz is passed through a magnetising coil within the probe to produce an alternating magnetic field. In use, the Hall devices are positioned over and in close proximity to an engraved “control patch” portion of the cylinder and an adjacent non-engraved portion of the cylinder. The alternating magnetic field is weakened by eddy currents which are produced in the cylinder by the induction between the magnetising coil and the surface of the cylinder. The Hall device positioned over the non-engraved area is subject to a maximum reduction in the field strength by the eddy currents, whilst the Hall device position over the engraved area is subject to a lesser reduction. The two Hall devices are connected in such a way that the two output signals oppose each other so that the resulting output signal provides a measure of the difference in the reduction in magnetic field strength, which according to this document gives a measure of the volume of metal that has been removed.

There are a number of disadvantages associated with the apparatus and method described in U.S. Pat. No. 3,931,570. In particular, simultaneous readings of engraved and non-engraved areas are required for comparison purposes. The method and apparatus is only suitable therefore for measuring the reduction in the magnetic field strength in the region of engraved control patches. The method and apparatus is entirely unsuitable for measuring other areas of the fully engraved cylinder where an engraved area may extend over several square meters. In addition, the Hall devices operate at relatively -low frequencies, 4 kHz to 50 kHz in this document, and are therefore affected by relatively deep (1 mm-0.2 mm) discontinuities in the cylinder, for example depth fluctuations in the copper coating within which the cells are formed. At these frequencies sub-surface discontinuities can have a significant affect on the response of the probe and these can readily cause inaccurate readings to be obtained which are not representative of the volume of material removed from the cylinder. Hall devices are generally used in applications where sensitivity and size are unimportant and in this respect it has not been possible to use Hall devices to obtain measurements to the degree of accuracy and repeatability required to measure the actual volume of metal removed from engraved areas on gravure cylinders.

According to an aspect of the invention there is provided a method of measuring the average engraved surface depth of an engraved area; the said method comprising the steps of:

positioning a micro strip signal line conductor in close proximity to an area of the engraved surface; the signal line conductor being positioned a predetermined distance from the surface so that the signal line conductor, conducting surface and dielectric air gap between the conductor and conducting surface of the engraved area constitute a micro strip transmission line having a characteristic impedance;

measuring the characteristic impedance of the said transmission line;

determining a value indicative of the engraved surface depth of the area of the said engraved surface in accordance with the said measured characteristic impedance of the micro strip transmission line.

This aspect of the invention is based on the observation that sensing the change in the characteristic impedance of the micro strip transmission line due to the varying thickness of the air gap, or dielectric medium, as a result of the engraved indentations is representative of the average surface depth.

The operating frequency of the transmission line is determined by the requirements for obtaining an effective impedance with a relatively small track width of the signal line conductor and so that the skin depth is small compared with the depth of the indentations.

The method according to this aspect of the invention allows the average engraved volume (or average engraved surface depth) of an area of an engraved surface to be determined directly in a single operation. The average surface depth may be determined either during the test pattern engraving process at set up time to calibrate the machine, during the cylinder engraving process itself as an in-process inspection step for closed loop feed-back control in so called “adaptive machining”, or subsequently after engraving to determine the average engraved volume of an engraved area. By directly determining the average engraved depth of an engraved area it is possible to improve quality control throughout the engraving process, and subsequently when the engraved item is despatched to a customer for use in a process such as gravure printing. In gravure printing it is necessary to check the parameters of the engraved item prior to acceptance and its use in a gravure printing press.

According to an aspect of the invention there is provided a method of measuring the average engraved surface depth of an engraved area; the said method comprising the steps of:

positioning an inductor means in the region of the said engraved surface and inducing eddy currents in the said engraved surface;

measuring changes in electrical properties of the said inductor means or further inductor means in proximity to the surface in response to the said induced eddy currents; and,

determining a value indicative of the average engraved surface depth of the area of the said engraved surface in accordance with the said inductor response.

The inventors have found that it is possible to accurately determine the average engraved surface depth of an engraved area by using an eddy current sensor. By positioning an inductor coil in the region of the engraved surface and inducing eddy currents in the engraved item the inventors have found that the impedance and/or voltage of the inductor coil correlates to the average engraved volume of the area in the region of the inductor. The inventors have found that there is a direct relationship between the measured impedance or voltage of the inductor and the average engraved surface depth of the area in the region of the inductor.

In this description it is to be understood that the terms “average engraved volume” and “average engraved surface depth” are used interchangeably in the sense that “average surface depth” refers to the average depth of material removed from the surface if the material removed was removed from the whole surface area not just the engraved cells or indentations formed by the engraving process. This is an important consideration in the context of gravure or flexographic printing because an average surface depth reading due to engraving of say 11 microns equates to 11 millilitres (of ink) per square meter. Average surface depth may therefore be considered to be the same value as the wet ink requirement in millilitres per square meter which is the usual parameter used in printing. There is a direct relationship therefore between the calibrated output of the microstrip transmission line characteristic impedance or the eddy current sensor concerning the average engraved surface depth and the ink requirement of the engraved area per square meter.

Preferably, the operating frequency range of the microstrip or inductor is in the range 1 mHz to 500 mHz. In preferred embodiments, the centreband operating frequency of the said inductor means is in the range 10 to 100 mHz. In one particular embodiment the preferred centreband frequency is 48 mHz. However, this frequency is not absolutely critical. The invention only requires that the operating frequency is such that there is substantially no eddy current penetration beyond the engraved depth of the surface because of the high operating radio frequency used or that a reasonable characteristic impedance can be achieved with a minimum signal line conductor track width in the microstrip aspect of the invention. In this aspect of the invention it is only necessary to follow the surface of the material, effectively measuring the amount of material lost from the surface i.e. by engraving. There is no subsurface information of interest and any discontinuities in the subsurface would adversely affect the accuracy of the output signals obtained and thereby the accuracy of the measurement being made.

Preferably, the step of determining a value of the average engraved surface volume comprises the step of comparing an output signal from said inductor means or the characteristic impedance of the transmission line with at least one predetermined calibration value representative of a respective average engraved volume. The inventors have found that by applying at least one pre-determined calibration factor to the value of the measured voltage across the inductor, or the characteristic impedance of the transmission line it is possible to determine the average engraved depth of an area for a range of engraved cell sizes. By comparing an engraved calibration surface with a non-engraved surface it is possible to determine a calibration factor or characteristic for the inductor means or measured characteristic impedance.

The inventors have found that by measuring a parameter known as “lift off”, that is the change of inductor impedance due to changes in the distance of the inductor from the surface being monitored, it is possible to relate this parameter to the average engraved volume of an area of the surface. The inventors have found that it is possible to measure the average air gap, which may be considered to be analogous to lift off, below the surface since the sensor provides an output signal which is a direct measure of the average air thickness (non conducting layer) in three dimensions notwithstanding irregular shaped indentations below the surface. This is also an important consideration because some gravure cells are very complex 3D shapes.

Preferably, the said output signal is further compared with a pre-determined calibration value for a non-engraved area of the engraved component.

Preferably, the engraved surface is an engraved gravure printing surface of a gravure cylinder. By measuring the average engraved surface depth of areas on an engraved gravure cylinder it is possible to determine whether the engraving machine is correctly calibrated. It is also possible to determine whether the cylinder is being engraved within acceptable tolerance limits so that the engraving machine may be re-calibrated if necessary and the engraved cylinders rejected if outside acceptable tolerances. In addition, it is possible for an engraved gravure cylinder to be inspected by a print technician prior to use in a printing press, for instance, so that a comparison can be made between different cylinders to be used in batch printing processing where more than one cylinder may be used. In addition; the above method readily enables a print technician to monitor wear on the engraved surface over time. This is important since the engraving stylus moves through a very small range of distances, approximately up to 100 micrometers (μm) and therefore wear of a few micrometers will result in a significant reduction in the average cell volume of the engraved surface area. By monitoring changes to the average engraved volume the print technician can readily determine when the gravure cylinder requires replacement due to wear.

In preferred embodiments, the method further comprises the step of processing the output signal to determine other parameters including the average dry ink volume for the measured engraved print surface area. This information may be important to the print technician when determining surface wear of the cylinder so that the average dry ink volume required for the engraved print surface area can be adjusted accordingly. In this way, it is possible for the print technician to determine the volume of ink required for an engraved print surface area even if the cylinder is worn by a few microns or so. For large print runs this can significantly reduce waste as the print technician will have a clear indication of the amount of dry ink required. In addition, if the output signal indicates that the average engraved surface depth is greater than a desired surface volume for a particular print density, the average dry ink volume can be altered so that each cell receives the same amount of dry ink but in a less concentrated ink solution. In this way it is possible to adjust the ink concentration in response to the measured average engraved surface depth being less or greater than the required engraved depth without affecting print density and/or print quality.

Preferably, the above method further comprises the step of processing the output signal to determine the thickness of a surface coating to be applied to the engraved area to reduce the average engraved depth below a predetermined threshold value. It is possible to compensate for oversized cells engraved in the engraved surface by applying a coating to the surface to reduce the average engraved depth of the area. Gravure cylinders are usually provided with a copper plated surface of say up to 1 mm thickness which is engraved by the engraving stylus, electrode or laser beam before a hard wearing chromium surface is plated onto the copper layer. Chromium plating causes the average engraved depth to be reduced and in this respect the thickness of the chromium layer can be adjusted during plating so that the average cell volume is within the required tolerances for the cylinder. Typically, if the cells are engraved oversize a thicker coating of chromium plate can be applied to the copper layer, and conversely if the cells are engraved undersize a thinner layer of chromium can be applied. For a correctly sized cell the layer of chromium will typically be within the region of 7 micrometers.

According to another aspect of the invention there is provided an engraved depth measurement device for measuring the average engraved surface depth of an engraved area; the device comprising:

a microstrip signal line conductor for positioning a predetermined distance from the engraved surface so that the signal line conductor, engraved surface comprising a conducting material and an air gap between the conductors constitutes a micro/transmission line;

means for measuring the characteristic impedance of the said transmission line; and,

processing means for determining a value indicative of the engraved surface depth of the area of the engraved surface in accordance with the said measured characteristic impedance.

According to another aspect of the invention there is provided an engraved depth measurement device for measuring the average engraved surface depth of an engraved area; the said device comprising:

an inductor means for inducing eddy currents in the said engraved surface;

means for measuring the electrical response of the said inductor means or other inductor means in proximity to the surface to the said eddy currents;

processing means for determining a value indicative of the average engraved surface depth of the area of the said engraved surface in accordance with a measured response of the said inductor.

According to a further aspect of the invention there is provided a method of engraving a workpiece comprising the steps of:

engraving an area on a workpiece;

positioning an inductor means in the region of the said engraved surface and inducing eddy currents in the said engraved surface;

measuring the electrical response of the said inductor means or other inductor means in proximity to the surface; and,

determining a value indicative of the average engraved surface depth of the area of the said engraved surface in accordance with the measured response of the said inductor;

comparing the average engraved depth so determined with a desired average depth for the said area;

adjusting engraver control parameters in accordance with the said comparison such that the average engraved depth of a subsequent area corresponds substantially to the said desired average volume.

According to another aspect of the invention there is provided an engraving system for engraving a workpiece; the said system comprising:

an engraving means for engraving a workpiece;

an inductor means for inducing eddy currents in the said engraved surface;

means for measuring the electrical response of the said inductor means or other inductor means in proximity to the surface;

processing means for determining a value indicative of the average engraved surface depth of the area of the said engraved surface in accordance with a measured response of the said inductor; and

comparison means for comparing the average engraved depth so determined with a desired average volume for the said engraved area;

a means for adjusting engraver control parameters in accordance with the said comparison such that the average engraved depth of a subsequent area corresponds substantially to the said desired average depth.

According to another aspect of the invention there is the use of an eddy current probe to measure the volume of air in the region on the underside of the probe when positioned on an engraved surface

It will be appreciated that the above mentioned aspects of the invention enable the print technician to specify the technical characteristics of gravure cylinders or plates, reject cylinders or plates that are outside the required specification, reduce time that is wasted installing cylinders and plates on a printing press that are outside the required specification, adjust ink concentrations in accordance with average cell volume measurements for the cylinders or plates, compare cylinders or plates from different manufacturers or suppliers, reduce ink wastage when the cylinders or plates are oversize, and order cylinders and plates from manufacturers regardless of the method used to produce the cells. The invention also readily enables the print technician to determine “release” values for a cylinder or plate, that is to say the amount of ink released from the cells on printing. This is important since it readily enables the print technician to calculate dry ink requirements, that is the amount of dry ink in grams per square meter, or other units, for a particular cylinder or plate.

By knowing the value for the average volume, the dry weight of the ink or coating transferred to the substrate can be calculated. This is an important parameter for the print or coating technician, as they often specify the coating weight required in grams per square metre. There are three parameters needed to calculate the dry coating or ink weight transferred to the substrate. It will be appreciated that dry weight is emphasized here because some printers use wet values, which is unreliable because of evaporation between taking the sample and measuring it. With the present invention it is possible to determine the average cell volume. The release value, which is the amount of ink or coating released from the cells during printing, is unknown. The release value is dependant upon many factors, such as, the cell shape, method of producing the cells, (mechanical or chemical engraving leaves cleaner internal cells than laser engraving, therefore the release is higher) the ink, the printing press or process characteristics. The release value can vary between 50% and 99%, but is very constant for a given set of parameters. The solid content value, which is the percentage amount of solids (pigment or metals) in the ink or coating, is also known. The inks or coatings are made up of different pigments, metals, solvents and mediums, at different viscosities. The only part that ends up on the substrate in dry form, is the solid content of the mixture. The solid content is a known value.

Grams per square metre of dry ink or coating transferred to the substrate is also a known parameter, most printing companies have an in house laboratory, and can use several different methods to measure the dry coating weight. One method is to weigh a piece of printed material with the dry ink or coating on, then wash the ink or coating off, and re weigh the material, then determine the value of the weight of ink or coating per square metre. This value is always stated in grams per square metre. This is vital for many applications, an example is a typical food bag for salad or lettuce, these bags are coated on the inside with an Anti Mist coating. The weight of this coating is usually specified in the range of 1 to 2 grams per square meter, outside of this range is either ineffective or has an influence on the transparency. Another example is the typical chocolate bar wrapper, the inside of these wrappers have what is called a Cold Seal, this is basically, a glue to close and seal the chocolate bar. The amount of glue required is stated in grams per sq mtr, and is critical to its effectiveness. Too much, and the wrapper cannot be opened, too little and the chocolate bar may not be sealed. Typical values for this are between 3 and 4 grams per sq mtr. Most printers know the weight of coating or ink required, but hitherto the volume and release have not been known. With the present invention since the average surface volume can be accurately determined from the average surface depth measurement and the required gram weight is known, the release value can be back calculated, and experience built up for different conditions. For example, if the volume is 14 ml per sq mtr, the solid value 100% and the release value 100%, the gram weight would be 14 grams per sq mtr. If a surface had a volume of 14 ml sq mtr, a solid content of 50% and a dry gram weight of 3.5 grams sq mtr, it is possible using the invention to back calculate the release value. For example, 14 ml sq mtr volume×50% solids=7.0 grams per sq mtr, but if the dry gram weight is only 3.5 Grams per sq mtr, the difference would be retained in the cells.

The present invention therefore allows the release value to be calculated for a given set of parameters. Hitherto, this has not been possible because the accuracy of the known surface engraved volume measurement methods has been in the region of+/−10%. The method and apparatus of the present invention readily enables an accuracy of+/−0.5% to be achieved, or accurate to+/−0.1 to 0.2 millimetres per square meter with a repeatability of+/−0.1%.

In one embodiment the apparatus of the present invention has the function of inputting release and solids values, and calculating Grams per sq mtr of dry weight to be transferred.

It will be appreciated that ink and colour, are different. Colour is measured in density, by densitometry, or spectrophotometers or similar means. Different substrates give different densities for the same volume of ink. The different substrates are numerous, with non-absorbent and absorbent (to differing degrees), with differing reflectance properties. Absorbency and reflectance have a big influence on density. By using the apparatus and method of the present invention the inventors have found that the non-absorbent materials have a saturation point for volume, that is to say, there is a volume in mls per sq mtr, after which the density does not increase. Typically, the volume supplied is in the range of one to two times the saturation volume, for example at around 8 ml sq mtr on the non-absorbent materials. This aspect of the invention therefore is capable of significantly reducing the amount of inks or coatings used on these on these materials, which inks and coatings are a significant cost in the process.

Various embodiments of the invention will now be more particularly described by way of example only with reference to the accompanying drawings, in which:

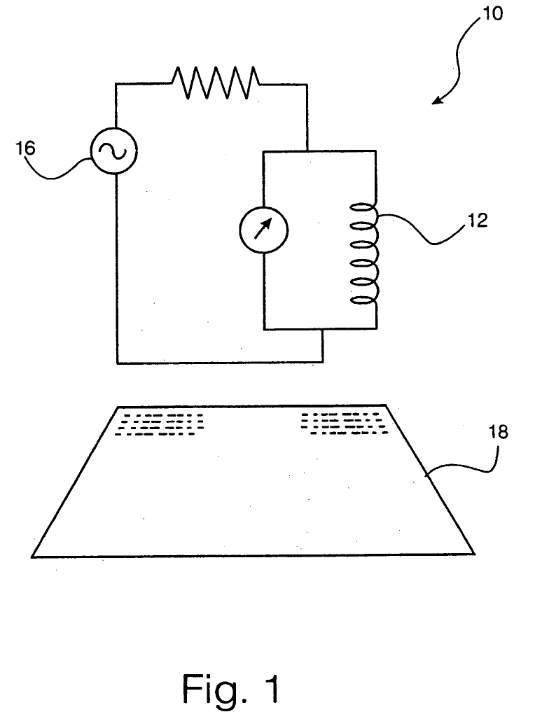

FIG. 1 is a schematic view of an eddy current probe positioned in relation to an engraved surface to be inspected;

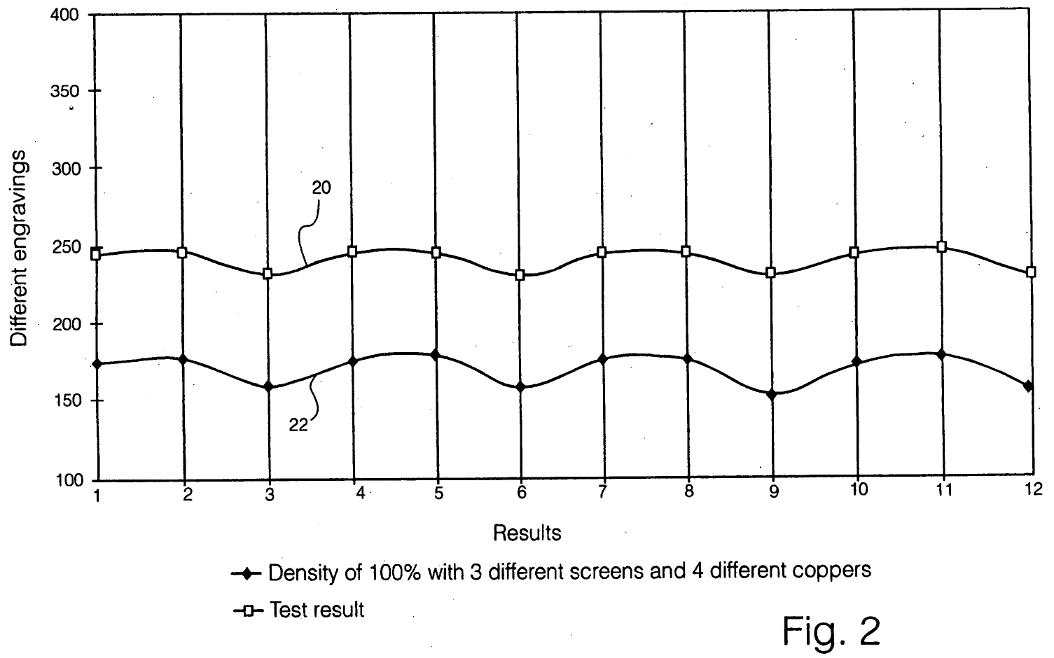

FIG. 2 is a graphical representation of test results obtained using the apparatus of FIG. 1 on an engraved gravure cylinder or printing plate.

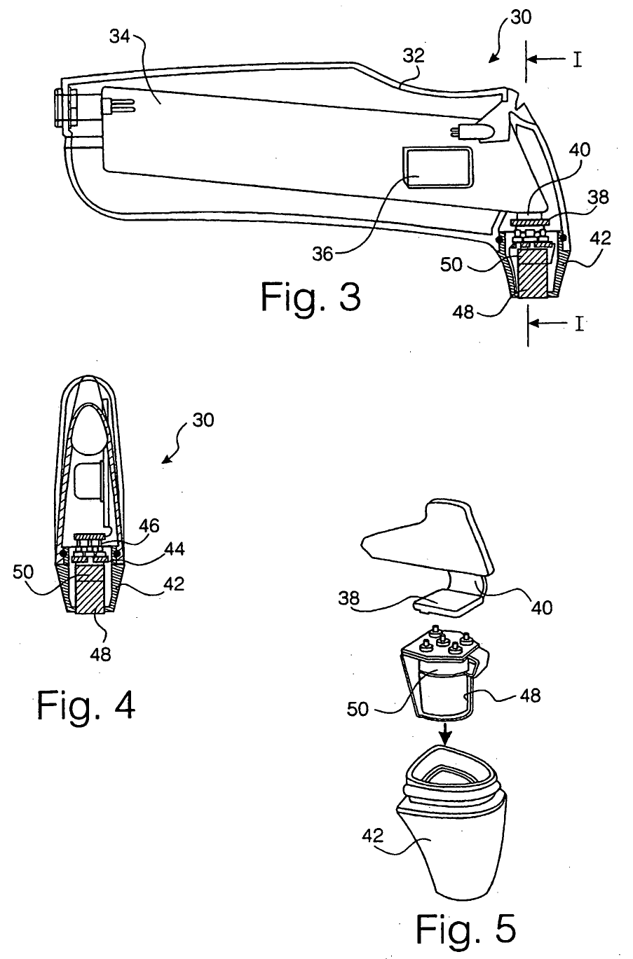

FIG. 3 is a side view of an eddy current probe according to an arrangement of the invention.

FIG. 4 is a section view along the line I-I of FIG. 3; and

FIG. 5 is an exploded view of the components at the tip of the sensor of FIG. 3.

Referring to FIG. 1 an eddy current sensor 10 comprises an inductor coil 12 connected in parallel with a voltmeter 14 which measures the voltage of the inductor 12. The inductor 12 and the volt meter 14 are connected electrically to an alternating current (AC) voltage supply 16. The coil 12 is positioned in close proximity to an engraved surface 18 of a gravure printing cylinder. When an AC current flows in the coil 12 the magnetic field of the coil induces circulating eddy currents in the surface 18 of a gravure cylinder, only part of the surface of which is shown in the drawing of FIG. 1. The size and phase of the eddy currents affect the load on the coil 12 and its impedance. The engraved cell indentations on the surface of the gravure cylinder interrupt the flow of the eddy currents in the surface and decrease the load on the coil 12 and therefore its impedance. In this respect the voltage across the coil measured by the volt meter 14 provides an indication of the average engraved volume of the gravure cylinder 18.

The apparatus 10 is optimised in terms of its operating frequency so that its standard depth of penetration in copper and/or chromium is of the order of, say 10-100 microns. In this way the apparatus is only responsive to defects in the surface due to the engraved cells.

Test results obtained using an eddy current probe of the type described in FIG. 1 are shown for a plurality of engraved gravure print surfaces in FIG. 2. In FIG. 2, the test results are presented in graphical form for 12 engraved areas on different gravure cylinders. FIG. 2 shows two lines, the upper one 20 of which represents a millivolt output value for the eddy current probe when positioned in proximity to the engraved surfaces. The lower characteristic 22 is representative of the average cell volume for cells in the respective engraved surfaces as determined using traditional optical and/or depth sensing methods. As can be seen in FIG. 2, the test data shows a clear correlation between the output signal of the eddy current apparatus and the measured cell volumes for each of the engraved areas. The higher millivolt results correlating to those cells having a higher engraved volume and the lower voltage readings relating to those cells having a smaller engraved volume.

The variation in the eddy current probe readings for each of the engraved areas shows that the output reading of the eddy current inductor voltage is proportional to the average engraved volume of the respective engraved areas. In this way it is possible to determine a calibration factor so that the output voltage may be directly related to the average engraved volume of the engraved areas. The apparatus 10 may also be provided with an appropriate circuit and/or software to allow to the output reading of the eddy current probe to be switched between different output voltage readings, for instance, to provide an output signal indicative of average cell depth, the predicted print density of the cell, the dry ink requirement of the cell or the required chromium thickness to be applied to obtain the required average engraved volume for the area.

Referring to FIG. 3 a handheld eddy current sensor probe 30 comprises a generally elongate casing 32 housing a main PCB 14 and a radio frequency oscillator 36. The PCB 34 is electrically connected to a sensor PCB 38 by a flexible strip like connector 40. The probe 30 further comprises a tip 42 which encloses a further printed circuit board 44 electrically connected to the printed circuit board 38 by means of 5 spring pin type electrical contacts 46. The circuit board 44 comprises a pair of radio frequency flat printed coils (not shown) one of which is an active coil, that is to say it is influenced by the material under the tip 42 being measured or inspected, and the second coil is a reference coil that is screened from the underside of the sensor and thereby the material being tested. The coils are electrically connected in such a way that any change in the balance of the coils is due to external factors, for example the influence of eddy currents in the item being tested or inspected.

An electrical insulating compression block 48 is provided at the tip of the sensor for contact with the surface of the item being tested or inspected. The compression block 48 may comprise polypropalene or cork material but other non conductive materials may be used. The compression block 48 is connected directly to a pressure sensor 50 which monitors the pressure applied by the user to the surface of the item being inspected through the compression block 48. The pressure sensor 50 is electrically connected to the PCB 44 so that output signals from the coils are only provided when the pressure measured by the sensor 50 is at a predetermined value or narrow range of values. The pressure sensor 50 therefore ensures that the output from the coils is consistent and is not affected by compression of the surface being inspected or non contact of the block 48 with the surface.

In use, the sensor coils are placed in close proximity to the conducting material of an engraved surface to be measured. The coils together with the dielectric block 48 and air gap due to the indentations creates a microstrip transmission line with the engraved surface comprising a grand plane. The characteristic impedance of the transmission line is indicative of the “air gap” or average surface depth of the engraved surface. This measured impedance is processed by the PCB electronics and compared with a reference value to provide an output signal representing the average surface depth.

Although aspects of the invention have been described with reference to the embodiments shown in the accompanying drawings, it is to be understood that the invention is not limited to those precise embodiments and that various changes and modifications may be effected without exercise of further inventive skill and effort. For example the sensor may comprise a separate excitation coil for inducing eddy currents in the material being inspected.

1. A method of measuring the average engraved surface depth of an engraved area; the said method comprising the steps of:
positioning an inductor means in the region of the said engraved surface and inducing eddy currents in the said engraved surface;
measuring changes in electrical properties of the said inductor means or further inductor means positioned in proximity to the said surface in response to the said induced eddy currents; and,
determining a value indicative of the average engraved surface depth of the area of the said engraved surface in accordance with the said inductor response.

2. A method as claimed in claim 1 wherein the step of determining a value of the average engraved surface depth comprises the step of comparing an output signal from said inductor means or further inductor means with at least one predetermined calibration value representative of a respective average engraved volume.

3. A method as claimed in claim 2 wherein the said output signal is further compared with a pre-determined calibration value for a non-engraved area of the engraved component.

4. A method as claimed in any preceding claim wherein the operating frequency range of the said inductor means is in the range 1 mHz to 500 mHz.

5. A method as claimed in claim 4 wherein the centreband operating frequency of the said inductor means is in the range 80 to 100 mHz.

6. A method as claimed in claim 5 wherein the centreband operating frequency of the said inductor means is substantially in the region of 96 mHz.

7. A method as claimed in any preceding claim wherein the said engraved surface is an engraved printing surface.

8. A method as claimed in claim 7 comprising the step of processing an output signal from the said inductor means to determine the average engraved cell depth or engraved volume.

9. A method as claimed in claim 8 comprising the step of processing the said output signal to determine the average dry ink volume for an engraved print surface area.

10. A method as claimed in any preceding comprising the step of processing an output signal of the said induction means or further inductor means to determine the thickness of a surface coating to be applied to the said engraved area to reduce the said average engraved depth below a pre-determined threshold value.

11. A method as claimed in any preceding claim wherein the operating frequency of the said inductor is such that there is substantially no eddy current penetration beyond the engraved depth of the surface.

12. An engraved depth measurement device for measuring the average engraved depth of an engraved area; the said system comprising:
an inductor means for inducing eddy currents in the said engraved surface;
means for measuring the electrical response of the said inductor means or further inductor means in proximity to the said surface to the said eddy currents;
processing means for determining a value indicative of the average engraved depth of the area of the said engraved surface in accordance with a measured response of the said inductor.

13. Apparatus as claimed in claim 12 comprising comparison means for comparing an output signal from said inductor means or further inductor means with at least one predetermined calibration value representative of a respective average engraved volume.

14. Apparatus as claimed in claim 13 wherein the said output signal is further compared with a pre-determined calibration value for a non-engraved area of the engraved component.

15. Apparatus as claimed in any one of claims 12 to 14 wherein the operating frequency range of the said inductor means is in the range 1 mHz to 500 mHz.

16. Apparatus as claimed in claim 15 wherein the centreband operating frequency of the said inductor means is in the range 80 to 100 mHz.

17. Apparatus as claimed in claim 16 wherein the centreband operating frequency of the said inductor means is substantially in the range 95 to 97 mHz.

18. A method of engraving a workpiece comprising the steps of:
engraving an area on a workpiece;
positioning an inductor means in the region of the said engraved surface and inducing eddy currents in the said engraved surface;
measuring the electrical response of the said inductor means or further inductor means positioned in proximity to the said surface; and,
determining a value indicative of the average engraved surface depth of the area of the said engraved surface in accordance with the said response of the said inductor;
comparing the average engraved surface depth so determined with a desired average depth for the said area;
adjusting engraver control parameters in accordance with the said comparison such that the average engraved volume of a subsequent area corresponds substantially to the said desired average volume.

19. A engraving system for engraving a workpiece; the said system comprising:
an engraving means for engraving a workpiece;
an inductor means for inducing eddy currents in the said engraved surface;
means for measuring the electrical response of the said inductor means or further inductor means positioned in proximity to the said;
processing means for determining a value indicative of the average engraved volume of the area of the said engraved surface in accordance with a measured response of the said inductor; and
comparison means for comparing the average engraved volume determined with a desired average volume for the said engraved area;
a means for adjusting engraver control parameters in accordance with the said comparison such that the average engraved depth of a subsequent area corresponds substantially to the said desired average volume.

20. Use of an eddy current device in the measurement of the average engraved volume of an engraved area.

21. Use of an eddy current probe to measure the volume of air in the region on the underside of the probe when positioned on an engraved surface.

22. An engraved depth measurement device for measuring the average engraved depth of an engraved area; the said device comprising
an induction means for inducing eddy currents in the said engraved surface;
pressure sensor means for determining the contact pressure of the said device with the surface being measured;
means for measuring the electrical response of the said indicator means or further indicator means of the said device in response to the said pressure sensor measuring a pre-determined applied pressure to the said surface.
